(19) United States
(12) Patent Application Publication
(10) Pub. No.: US 2025/0173809 A1
(43) Pub. Date: May 29, 2025

(54) NETWORK SYSTEM TO UTILIZE MATCHING OF BACKUPS FOR JOB ORDERS

(71) Applicant: Uber Technologies, Inc., San Francisco, CA (US)

(72) Inventors: Shahrouz Takyar, San Francisco, CA (US); Tian Liu, San Francisco, CA (US); Li Li, San Francisco, CA (US); Sahar Hemmati, San Francisco, CA (US); Shanchuan Xia, San Francisco, CA (US)

(21) Appl. No.: 18/961,227

(22) Filed: Nov. 26, 2024

Related U.S. Application Data
(60) Provisional application No. 63/604,088, filed on Nov. 29, 2023.

(51) Int. Cl. G06Q 50/47; G06Q 10/0631

(52) U.S. Cl. CPC G06Q 50/47; G06Q 10/06311

(57) ABSTRACT

The network system generates a job order for a received transport request. During a first time interval, the network system performs a matching process to match the job order to multiple service providers, including a first and second service provider. The network system transmits a first communication that specifies the job order to a computing device of the first service provider to enable the first service provider to exclusively accept or not accept the job order. In response to the first service provider not accepting the job order, the network system transmits, without reperforming the matching process, a second communication that specifies the job order to a computing device of the second service provider to enable the second service provider to exclusively accept or not accept the job order using the computing device of the second service provider.

### RELATED APPLICATIONS

This application claims benefit of priority to Provisional U.S. Patent Application No. 63/604,088, filed Nov. 29, 2023; the aforementioned priority application being hereby incorporated by reference in its entirety.

### TECHNICAL FIELD

Examples provide for a network system to utilize matching of backup providers for job orders.

### BACKGROUND

Under conventional approaches, on-demand services distribute service requests (e.g., transport requests) as job orders that are exclusively available to matched service providers. For example, a newly received transport request can be structured as a job order that is matched with and communicated to an available service provider. The service provider can then accept or reject the job order, either through affirmative action (e.g., interaction through user device) or through no-action (e.g., by default). In cases where the job order is rejected, the job order is typically re-matched to a different service provider. Often, the re-matching process entails queuing the job order until the next instance when the matching process is performed.

On-demand services typically perform matching processes to match service requests with service providers on a periodic basis (e.g., every 10 seconds). By performing the matching process periodically, the matching process can generally produce better matching results. For example, a greater number of job orders can exist for the matching process, based on new transport requests being received in the time interval between when matching is performed. Furthermore, more service providers may be available for the matching process. This allows the network system to better optimize the matching process for pre-determined objectives (e.g., wait-time of individual users). Further, by implementing the matching process on a periodic, time-interval basis, the on-demand system is better able to use its computational and networking resources in conjunction with implementing the matching process. For example, the network system can utilize a common objective function to optimize the matching process for predetermined objectives. If, on the other hand, the matching process is performed responsive to transport requests as they come in, then the network system could incur inefficiencies (e.g., multiple processing threads) with limited ability to optimize the matching process for unmatched service requests using a common objective function.

### BRIEF DESCRIPTION OF THE DRAWINGS

FIG. 1 illustrates a network system for matching drivers to service requests, according to one or more examples.

FIG. 2 illustrates an example method for matching a job order to multiple service providers, according to one or more embodiments.

FIG. 3 illustrates an example method for matching open job orders to available service providers, according to one or more embodiments.

FIG. 4 is a block diagram that illustrates a computer system upon which one or more embodiments described herein may be implemented.

### DETAILED DESCRIPTION

Examples provide for a network system that matches individual service requests to multiple service providers at one time. The network system makes a job order that is based on an unmatched transport request exclusively available to a first one of the matched service provider (e.g., a primary service provider). In the event the first service provider does not accept the job order (e.g., via an input to actively accept or reject the job order, or after a predetermined amount of time has elapsed without the provider accepting or rejecting the job order), the network system automatically makes the job order exclusively available to a second one of the matched service providers (e.g., a backup service provider).

Among other technical benefits, the network system makes the job order exclusively available to the second service provider without re-matching (i.e., performing the matching process again) the job order. Upon determination of a job order being not accepted (or rejected) by a service provider, the network system can immediately make the job order exclusively available to a second service provider (e.g., as a backup), without delay, such as would otherwise be caused by the network system holding the rejected job order until the next time interval when the matching process is performed again. The network system can also improve efficiencies over conventional approaches by determining a backup service provider for a service request at the same time as the primary service provider.

In further examples, the network system can make job orders exclusively available to primary service providers to accept or reject for a duration that spans one or more periodic intervals where matching is performed, with at least some of the pending job orders also being associated with a corresponding backup service provider that is to exclusively receive the pending job order in the event the corresponding primary service provider does not accept the job order. While job orders are pending (or have a pending status) with one matched primary service provider, the network system can continue to perform the matching process at periodic intervals, using service providers that are identified at that time as being backup service providers to pending job orders. As a result of the matching process being performed, the backup service providers may be matched as primary service providers to other job orders, and/or alternative service providers can be determined as the corresponding backup service providers for pending service requests. By continuing to implement the matching process using backup service providers, the network system avoids limiting the pool of candidate service providers for future time intervals when matching is performed. Furthermore, the network system can maintain its optimization objectives by refreshing the backup service providers that are associated with pending job orders.

Still further, in some examples, the network system determines an approval (or acceptance) rate (e.g., a metric, measurement, etc.) for job orders that are to be made exclusively available to individual service providers. Depending on implementation, the approval rate of a job order may be determined based on one or more characteristics associated with the corresponding service request, such as the start and/or end location(s), distance, vehicle or service type requested, time of day or day of the week, cost and/or fee(s) associated with the service, etc. The network system can incorporate a determination of an approval rate in various facets of examples as described. For example, the approval rate of a job order can correspond to a metric or score that is indicative of a probability that the job order will be accepted by a service provider. Such approval rates may be determined based on historical data associated with job orders over a given duration of time. For a job order that has a relatively low approval or acceptance rate (e.g., lower than a predetermined threshold value rate), the network system can make the job order exclusively available to a backup service provider, while for a job order that has a high approval or acceptance rate (e.g., greater than a predetermined threshold value rate), the network system may limit or exclude either the determination, association and/or use of backup service providers. As another example, the network system can utilize approval rates when determining whether to associate a backup service provider of a pending job order as a primary service provider of an open job order. In such case, if the service provider is more likely to reject the open job order, then the network system may keep that service provider's association as backup to the pending job order.

According to examples, a network system receives, over one or more networks, a transport request. Based on the transport request, the network system generates a job order. During a first time interval, the network system performs a matching process to match the job order to multiple service providers, including a first service provider and a second service provider. Further, the network system transmits, over the one or more networks, a first communication that specifies the job order to a computing device of the first service provider but not to a computing device of any other service provider of the multiple service providers, where the first communication enabling the first service provider to accept or not accept the job order. In response to a determination that the first service provider does not accept the job order, the network system transmits, over the one or more networks, without reperforming the matching process, a second communication that specifies the job order to a computing device of the second service provider but not to a computing device of any other service provider of the multiple service providers. The second communication enables the second service provider to accept or not accept the job order using the computing device of the second service provider.

In additional examples, during a first time interval, the network system identifies a plurality of job orders, including multiple job orders that each have an open status such that no service provider is currently matched to the job order. The network system implements a matching process to match individual job orders with one or more service providers, wherein for each job order of the multiple job orders that have the open status, implementing the matching process includes determining a matched primary service provider. For a first job order of the multiple job orders with the open status, implementing the matching process includes determining each of the matched primary service provider and a matched backup service provider. For each job order of the multiple job orders having the open status, making the job order available to the matched primary service provider includes transmitting a first communication to a computing device associated with the matched primary service provider, the first communication enabling the matched primary service provider to accept or not accept the job order. For at least the first job order of the multiple job orders, if the matched primary service provider does not accept the first job order, a second communication is transmitted to a computing device associated with the backup service provider, where the second communication enables the matched backup service provider to accept or not accept the first job order.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Moreover, examples described herein can generally require the use of specialized computing devices, including processing and memory resources. For example, one or more examples described may be implemented, in whole or in part, on computing devices such as servers, desktop computers, cellular or smartphones, laptop computers, printers, digital picture frames, network equipment (e.g., routers), wearable computing devices, and tablet devices. Memory, processing, and network resources may all be used in connection with the establishment, use, or performance of any example described herein (including with the performance of any method or with the implementation of any system). For instance, a computing device coupled to a data storage device storing the computer program and configured to execute the program corresponds to a special-purpose computing device. Furthermore, any computing systems referred to in the specification may include a single processor or may be architectures employing multiple processor designs for increased computing capability.

Still further, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

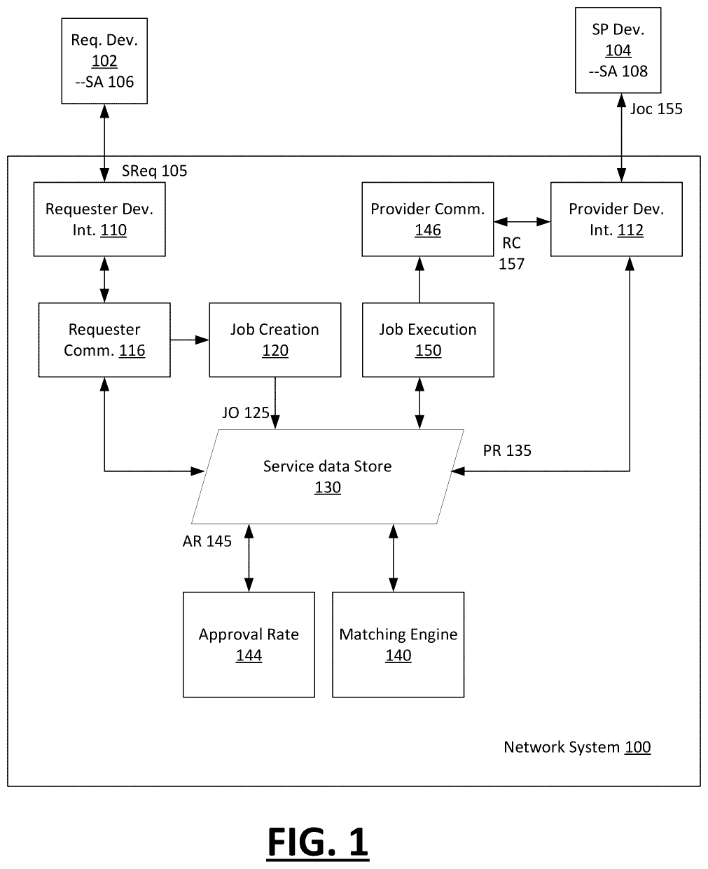

FIG. 1 illustrates a network system for matching drivers to service requests, according to one or more examples. In some examples, a network system 100, as illustrated with FIG. 1, enables a network platform in which users operate mobile computing devices of users access or implement functionality to facilitate the user's participation and use of a matching service. In examples, the users of the network system 100 include service providers (e.g., drivers who operate their own vehicles to transport riders) and requesters (e.g., riders who request and receive transport services from drivers). The transport service provided by the service provider may include a service in which the service provider operates a vehicle to transport the requester from a service start location (e.g., pickup location) to a service end location (e.g., destination or drop-off location). In variations, examples described with the network system 100 can be applied to other types of transport services, such as, for example, group transport (e.g., rider has friends or family who accompany the rider on the trip), pooled transport (e.g., driver picks up additional riders who separately request the transport service, typically with different pickup locations and/or drop-off locations), bus transport (e.g., driver transports multiple riders in large-capacity vehicle, sometimes while following a pre-determined route), or delivery transport (e.g., service provider picks up and delivers an item).

With reference to FIG. 1, the network system 100 includes a requester device interface 110, a provider device interface 112, a requester communication component 116, a job creation component 120, a service data store 130, a matching engine 140, an approval rate component 144, and a job execution component 150. Each service requester can operate a corresponding requester device 102 to utilize the network system 100. In examples, each requester can operate a service application 106, running on the corresponding requester device 102, to access information, generate service requests and receive services from the network system 100. Likewise, service providers can operate service applications 108 running on corresponding provider device 104 to make themselves available to the network system 100 as a resource or source for fulfilling service requests of requesters.

In examples, the requester device interface 110 represents processes that communicate with requester devices 102 to enable requesters to use services provided through the network system 100. The requester device interface 110 can communicate with requester devices 102 to receive service requests 105, receive information from requester devices 102, and provide information to requester devices 105, in conjunction with services provided through the network system 100. In examples, the requester device interface 110 receives transport-related service requests 105 from requester devices 102. The service requests 105 can specify parameters and other information for transporting a requester, designee, or object (e.g., package, food order, grocery, etc.). In context of transportation services, the service request 105 can specify parametric information that includes a service start location (e.g., pickup location) and a service end location (e.g., destination). Other parametric information that can be included with the service request 105 can include, for example, a service type (e.g., type of vehicle the user would like to be transported in), the current location of the requester, and timing information (e.g., a specific time the user would like to be picked up or arrive at their destination, an urgency of the service request, etc.). The types of services provided can also include transport-related services and delivery services (e.g., for food, groceries, or shipments).

The provider device interface 112 represents processes that communicate with provider devices 104 to enable providers to access and provide services through the network system 100. In examples, each service provider can operate a service application 108 on their respective service provider device 104 to make themselves available as a transport provider for requesters of the network system 100. In examples, each service provider makes themselves available as a transport provider by operating a service provider application 108 on their respective device 104. For example, a service provider can open a service provider application 108 and toggle an availability feature to make themselves available. The service application 108 transmits the availability status, along with the provider identifier and their current location to the provider device interface 112.

Once a service provider makes themselves available (e.g., goes “online”), the provider device interface 112 creates (or updates) a corresponding service provider record 135 that reflects a current location and status of the service provider. Subsequently, the provider device 104 can automatically communicate its current location to the network system 100, using the service application 108. Through use of the service application 108, the service provider can receive transport requests, and the service provider may operate a service vehicle to fulfill matched transport requests. Once the communication channel is established, the provider device 104 can automatically communicate service information to the network system 100, at repeated intervals or continuously. The service information may include the provider's identifier and the provider's current location, which may be determined by the service application 108 interfacing with a satellite receiver (e.g., GPS component or other location-aware resource) of the provider device 104.

### Job Creation

The job creation component 120 represents processes that create a record, referenced as a job order 125, for each service request 105 received by network system 100 (e.g., via requester device interface 110). Each job order 125 can specify parametric information of the service request 105, including the service locations of the service request 105 and other parametric information. Additionally, each job order 125 can specify a job status. In examples, the job status reflects whether a job order is open, pending or assigned. An open status refers to a job order 125 that is presently unmatched to a service provider. An open job order 125 can include newly created job orders for newly received transport requests 105, as well as job orders 125 which were previously matched but not accepted by a service provider. Pending job orders 125 can include job orders that are matched to a service provider, but which have not been accepted by a service provider. As described below, a pending job order can be made exclusively available for acceptance to one service provider for a time interval during which no other service provider can accept the job order 125.

In examples, each job order 125 can also be associated with a distribution type, such as an exclusive distribution or a batch distribution. An exclusive job order is one that is made exclusively available for acceptance (or rejection) during a particular time interval to a single service provider that has been matched to that job order 125. If the matched service provider does not accept the matched job order 125, then the job order 125 may be made exclusively available for acceptance to another matched service provider (e.g., a backup service provider). Alternatively, a job order 125 can be initially made available or changed to a batch type, where the job order 125 can be accepted by any one of multiple service providers that are identified in the batch, in accordance with a predetermined set of batch rules. In examples, batch job orders 125 can also be made exclusive, or vice-versa.

Accordingly, for each newly received service request 105, the job creation component 120 creates and stores a corresponding job order 125 with the active data store 130, where the status of the job order reflects it has an open status. The service data store 130 can also store service provider records 135 for active service providers. In examples, a status of the service provider can indicate whether the service provider is available or unavailable for matching. An available service provider includes a service provider that has an open status, meaning the service provider (i) does not have a pending job order 125 to accept or decline, and (ii) is not currently assigned to a job order 125. A service provider that has a pending status means the service provider has received a pending job order 125 to accept or decline. A service provider that is unavailable, or has an unavailable status, can include a service provider that accepts a job order 125. Conversely, if a service provider receives a job order 125 and then rejects it, the status of the service provider can change from pending to available.

### Matching Process

The matching engine 140 implements a matching process to match job orders 125 with service provider records 135. In examples, the matching process can be implemented repeatedly, such as at discrete time intervals (e.g., every 5 or 10 seconds, etc.). Further, in some examples, the matching process may be implemented as a group operation (or group-level matching process), where at each interval, every open job order 125 is matched to an available service provider, or vice-versa. Additionally, the matching engine 140 can optimize the matching process for one or more objectives, including one or more group objectives. For example, the matching engine 140 can match open job orders 125 to available service providers based on one or more objectives that include (i) minimizing a total (or group-level) wait time of requesters until pickup, and/or (ii) minimizing a total (or group level) distance traveled by service providers to reach the service start (or pickup) locations. As an addition or variation, the matching engine 140 can optimize the matching process for individual job orders 125 or service providers, such as by matching certain service requests with the service provider that is nearest to the service start location.

In examples as described, the matching engine 140 implements the matching process to solve one or multiple objective functions that are optimized for one or more objectives of the network system 100. The result of solving the objective function can include identifying multiple service providers for individual job orders 125. For example, the matching engine 140 can implement a matching process that identifies multiple available service providers for individual job orders 125, where each identified service provider furthers the objective(s) of the network system 100 to some degree and more so than other available service providers (e.g., as compared to selection of service providers through a randomized process). The matching process can also rank or prioritize available service providers that are matched to each job order 125 based on the objective(s) of the network system 100. For open job orders 125, the highest ranked service provider can correspond to the matched primary service provider, with the next highest representing the backup service provider. For pending job orders, the highest ranked service provider can correspond to a matched backup service provider. In this way, performance of the matching process results in matched job orders 125 having a primary matched service provider, and one or more backup matched service providers. As described below, in the event a primary service provider declines a job order 125, the network system 100 can immediately send the job order 125 (as an invitation or offer) to a matched backup service provider, without delay that would otherwise result if the job order 125 was held until the next time the matching process is performed.

In examples, at a given time interval, the matching engine 140 implements a first matching process by (i) identifying open job orders 125 from the service data store 130; (ii) identifying open service provider records 135 from the service data store; and (iii) matching each open job order 125 to an open provider record 135 as a primary matched service provider.

As described with examples, the matching process to identify primary and backup service providers is performed at one time, such that job orders 125 are matched to primary and backup service providers at one time.

During the same interval as the first matching process, examples provide that the matching engine 140 implements a second matching process by (i) identifying pending job orders 125 where a job order 125 has been communicated to a matched service provider; (ii) identifying pending and open provider records 135, reflecting the pool of open service providers who have not received a job order 125, as well as the pool of pending service providers who have received a job order 125 that they have not accepted or declined; and (iii) matching each pending job order 125 to the provider record 135 for one or more service providers that are to be backup for the pending job order 125. In examples, first and second matching processes can be implemented at one time, and/or as one process (e.g., solving the same objective function) during a given interval. In variations, the first and second matching processes can be implemented as different processes during the given interval. For example, the first matching process can be weighted or configured for a first objective (e.g., minimize group wait time), while the second matching process can be weighted or configured for a second and different objective (e.g., improving the likelihood of the job order 125 being accepted).

As described with examples, the matching of a job order 125 to a primary service provider results in the primary service provider exclusively receiving the matched job order 125 to accept or decline. If the primary service provider declines the job order 125, then the backup service provider exclusively receives the matched job order 125. Additionally, a duration provided for a service provider to exclusively receive and accept/not accept a job order 125 can span multiple time intervals during which matching is performed. In that duration, the backup service provider(s) matched to the job order can change, based on the results of the respective matching processes.

Upon completion of the matching process(es) during a given interval, each matched job orders 125 can reference or otherwise be associated with the service provider record 135 of a matched primary service provider. Additionally, at least some of the matched job orders 125 can also reference or otherwise be associated with the service provider record(s) 135 of one or more backup service providers. The combination of matched primary and backup service providers can be reflected by a priority or ranking designation between the referenced or associated service provider records 135 of the job order 125.

### Job Order Execution

Once matching is performed, processes represented by job order execution component 150 communicate matched job orders to the matched service providers. For each job order 125 that is processed by the matching engine 140, the job order execution component 150 can trigger a job order communication 155 to be transmitted to the device 104 of the respective matched primary service provider. For a given job order 125, the job order execution component 150 can utilize a provider communication component 146 to send a job order communication 155 to the current matched primary service provider.

In examples, a job order 125 is exclusively provided to the matched primary service provider. In at least some implementations, a job order 125 is exclusively provided to a matched primary service provider by the provider communication component 146 transmitting a corresponding job order communication 155 to the provider device 104 of the matched primary service provider, where the corresponding job order communication 155 enables the provider on the recipient provider device 104 to interact to either accept or not accept the job order 125. In examples, the job order communication 155 is not transmitted to any other provider device other than the matched primary service provider, and the job order communication 155 becomes inactive if the matched service provider does not accept the job order. In variations, the job order communication 155 is only active (e.g., interactive) when transmitted to the provider device 104 of the matched primary service provider. In this way, only the matched primary service provider can accept/not accept the corresponding job order 125 of a job order communication 155. Once a job order communication 155 is communicated to a matched service provider, the job execution component 150 can change the status of the corresponding job order to pending. Additionally, the status of the matched primary service providers can also be changed to reflect a pending status. Should the matched primary service provide not accept the job order communication, the job execution component 150 can identify a matched backup service provider for the job order (if one exists). The job execution component 150 can promote the matched backup service provider to a primary service provider, by causing the provider communication component 146 to send another job order communication 155 for the corresponding job order 125 to the newly promoted matched service provider. The status of the particular job order 125 can remain pending, while the status of the service provider who did not accept the job order 125 is changed from pending to open, and the status of the backup service provider who was promoted to receive the job order 125 is changed from open to pending. In this way, only one matched service provider (i.e., matched primary service provider) has the ability to accept or not accept a job order 125 at a time.

In examples, each job order communication 155 can be structured to include content that identifies parametric information about the matched job order, such as the service start and the service end locations. Each job order communication 155 can also include data for determining, or otherwise representing the fare (or compensation) the service provider will receive for fulfilling the job order 125. In examples, the job order communication 155 can be rendered as an application message (or “in-app message”) or notification by the service applications 108 of the receiving provider device 104. In some examples, the job order communication 155 can be communicated as a push notification or communication. As an addition or variation, job order communications 155 can be at least partially rendered by a respective service application 108 on receipt, such as in the form of an alert, notification or interactive message. The provider communication component 146 can also transmit job order communications 155 through alternative channels, such as third-party applications or services (e.g., SMS application).

The job order communications 155 can be structured to enable the respective service applications 108 running on the receiving provider devices 104 display information about the job order 125, such as information about the service locations and fare for fulfillment of the job order 125. The job order communications 155 can also include data to cause the receiving provider devices 104 to provide one or more interactive features for enabling the corresponding service provider to accept or decline the job order 125 through input interaction (e.g., screen tap, voice utterance etc.). In response to such provider interaction, a provider device 104 can generate a response communication 157 to a job order communication 155, where the response communication 157 indicates one of acceptance or rejection based on the provider input. The response communication 157 can include an identifier associated with the service provider, the invitation communication 155 and/or the corresponding job order 125.

In examples, the provider communication component 146 can receive incoming response communications 157, and job order execution component 150 can process the response communications 157 to update the status of the job order 125 and/or service provider record 135 based on the indication of the response communication 157.

For response communications 157 that indicate acceptance of the respective job orders 125, job order execution component 150 can change the status of the job order 125 to reflect the job order as being assigned. The status of the service provider record 135 may also be changed to reflect the service provider as being unavailable. The provider device interface 112 can communicate (or initiate communication of), for example, navigation content to the service provider device 104. The requester communication component 116 can update the requester device 102 of the matching, including information about the matched service provider and the estimated time which the service provider is to arrive at the service start location.

For response communications 157 that indicate rejections of the respective job orders 125, job order execution component 150 can make a determination as to whether the job order references or is otherwise associated with the provider record 135 of a backup service provider. If the job order 125 is associated with a backup service provider, the job order execution component 150 can then trigger a job order communication 155 to the referenced or associated backup service provider, with the job order communication 155 making the corresponding job order 125 exclusively available to the backup service provider. The job order execution component 150 can change the status of the initial primary service provider that rejected the invitation communication 155 to reflect the service provider having an open status. The job order execution component 150 can also change the status of the backup service provider who exclusively receives the job order communication 155 to reflect that service provider as having a pending status.

If the job order 125 is subsequently rejected again (e.g., by receipt of a response communication 157 from the provider device 104 of the backup service provider), job order execution component 150 can make another determination of whether another service provider is referenced or associated with the job order 125. If another backup service provider is referenced, then another job order communication 155 is sent out to the computing device of the backup service provider.

As an addition or variation, job order execution component 150 can also initiate a timer that coincides with the transmission or receipt of a job order communication 155, where the receiving service provider is exclusively provided the opportunity to accept or decline the job order communication 155. For each job order communication 155, the job order execution component 150 can monitor for response communications 157 for the duration of the timer. Upon expiration of the timer, the job order execution component 150 can implement a default action, which based on implementation, can be either to perform operations coinciding with acceptance by the service provider receiving the job order communication 155, or perform operations coinciding with the receiving service provider declining the job order communication 155.

The operations performed in response to a service provider accepting the exclusive job order communication 155 can include, for example, (i) changing status of job order 125 to assigned or closed; (ii) changing the status of the service provider to unavailable; (iii) initiating processes to communicate with the requester device 102 about the matched service provider and subsequent steps to fulfilment of the respective service request 105; and (iv) initiating processes to communicate, guide and/or monitor the service provider in fulfilling the service request 105.

The operations performed in response to a service provider not accepting or declining the exclusive job order communication 155 can include, for example, (i) sending the job order communication 155 to a predetermined backup service provider; (ii) changing the status of the initial service provider to open; and(iii) changing the status of the backup service provider receiving the job order communication 155 to pending.

In some examples, a timer can be initiated and/or made renderable on the service provider devices 104 with receipt of the job order communication 155. The job order communication 155 can include or otherwise initiate a timer feature on the receiving provider device 104 to indicate an amount of time the service provider has in order to accept or decline the job order communication 155, where expiration of the timer results in a default action or set of operations. In some examples, once the timer expires, the service provider is deemed to have not accepted or declined the job order 125. In variations, once the timer expires, the service provider is deemed to have accepted the job order 125. The designation resulting from expiration of the timer can be based on default settings or preferences of the service provider device 104 (e.g., such as specified through the service application 108) and/or of the network system 100.

### Approval Rate Usage

In examples, network system 100 can include an approval rate component 144 to determine an approval rate 145 for individual job orders 125. The approval rate 145 can include a score, a range, or other probabilistic metric that is indicative of the likelihood that the job order 125 will be accepted during a given time interval. For example, a higher approval rate can mean that a job order will likely be accepted by a matched service provider, while the low approval rate can reflect uncertainty or a likelihood that the job order 125 will be rejected by a matched service provider.

In examples, the approval rate component 144 can determine approval rate metrics that are based on characteristics of the job order 125. In such examples, the approval rate 145 can be based on characteristics of the job order 125 (e.g., service start location, service destination, fare amount, etc.), inferred characteristics (e.g., likely route taken by service provider) and/or contextual information (e.g., time of day, day of week, month, season, weather conditions, traffic conditions). By way of illustration, job orders 125 that have a particular service start location or route may be more desirable than job orders 125 that have out-of-the-way service start locations. In this way, the approval rate component 144 can use historical information to determine approval rates for individual job orders 125, based on one or more characteristics of the job order 125.

In variations, the approval rate component 144 can utilize service provider information to determine an approval rate of a job order 125. In particular, historical information about preferences or tendencies of matched service providers to accept or decline job orders 125 can be used to determine the approval rate of individual job orders 125. The historical information of individual service providers can be part of the service provider's profile information, which can be referenced by the service provider record 135.

In some examples, one or more predictive models can be used to determine the approval rate 145 of individual job orders 125. For example, one or more stochastic models can be developed for a particular geographic region to predict the likelihood of acceptance of individual job orders 125, where the stochastic models are trained on historical information for the particular geographic region and use input signals that include service locations and/or contextual information.

In some examples, the approval rate component 144 determines the approval rate 145 for a newly created job order 125 at or about the time the job order is created. In this way, each job order 125 can be associated with an approval rate 145. Based on implementation, the approval rate 145 can be binary (e.g., reflecting high or low acceptability), trinary (e.g., reflecting high, neutral or low acceptability), a score (e.g., score between 0 and 1 reflecting a probabilistic value of the job order 125 being accepted), or other determination (e.g., multivariate, conditional, etc.).

In examples, the matching engine 140 and/or job order execution component 150 can be implemented with rules or configurations that utilize or integrate the determined approval rate 145 for each job order 125. In some examples, the matching engine 140 determines when a backup service provider is to be determined for a job order 125 based on the approval rate 145 of the job order 125. For example, if the approval rate is greater than a threshold value (e.g., job order 125 is likely to be accepted), then the matching process may result in no backup service providers being matched to the job order 125.

In another example, a matching process to identify backup service providers (in addition to a primary service provider) is performed for each job order regardless of the approval rate. But if the approval rate 145 for the declined job order is above a threshold, the matching engine 140 rematches the job order rather than communicate the job order to one of the previously matched backup service providers (e.g., such as the highest ranked backup service provider). For example, during a first interval, the matching engine 140 matches each open job order to a matched primary service provider, and to multiple backup service providers, where the backup service providers are ranked for purpose of being matched to the job order. In the event the primary service provider declines a job order, the matching engine 140 uses the approval rate 145 to determine whether to rematch the job order to a new primary service provider (and one or more backup service providers) in a next time interval, or communicate the job order to the highest ranked backup service provider, where the determination is based at least in part on the approval rate (e.g., whether the approval rate is above a threshold). In this way, a job order that is likely to be accepted by a service provider can be rematched in a next matching interval, to enable the matching process to be optimized, while job orders that are less likely to be accepted may be matched to service providers that are identified as backups in the current matching interval.

The requester communication component 116 can monitor individual job orders 125 to determine a change in status of a job order. For example, when a matched service provider accepts a job order 125, the requester communication component 116 can communicate the change in status of the job order (e.g., job order is “assigned”, etc.) to the requester device 102 (via the requester interface 110) that transmitted the corresponding transport request. The requester communication component 116 can gather, for example, information about the matched service provider (e.g., using the corresponding service provider record 135) and update the requester as to information such as (i) information about the service provider, and (ii) estimated time until service provider arrives at the service start location. Likewise, if the job order 125 is rejected by, for example, a backup service provider, the requester communication component 116 can update the requester of the delay in arranging the service provider.

### Methodology

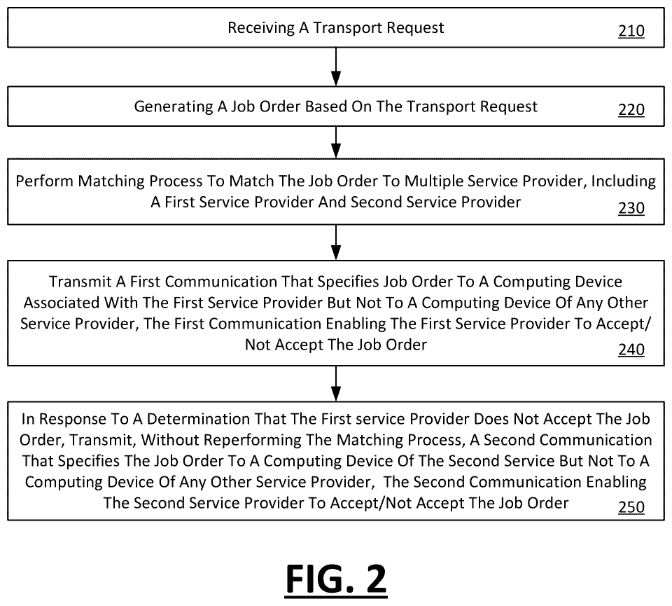

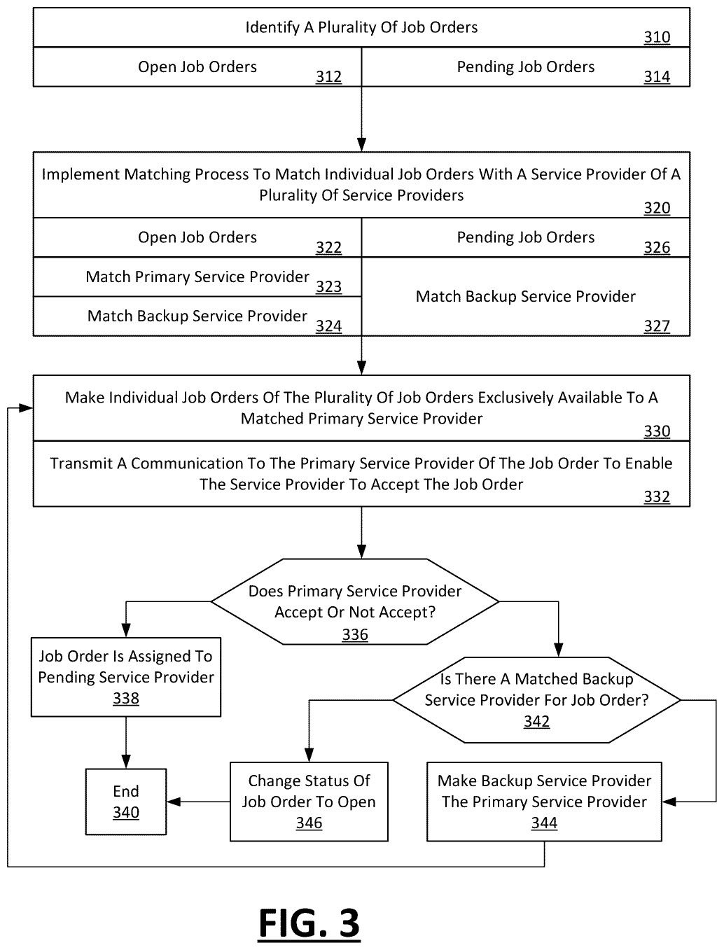

FIG. 2 illustrates an example method for matching a job order to multiple service providers, according to one or more embodiments. FIG. 3 illustrates an example method for matching open job orders to available service providers, according to one or more embodiments.

With reference to FIG. 2, in step 210, the network system 100 receives a transport request 105 from the requester device 102. The transport request 105 can specify parametric information, such as a service start location (e.g., pickup location) and service end location (e.g., destination).

In step 220, the network system 100 generates a job order 125 based on the transport request 105. The job order 125 can correspond to a record that includes the parametric information of the transport request 105. The job order 125 can be stored in a service data store 130, with provider records 135 of active service providers. As described examples, active service providers can be associated with availability statuses, including an open status, a pending status and unavailable status.

In step 230, the network system 100 performs a matching process to match the job order to multiple service providers, including a first or primary service provider and a secondary or backup service provider. The matching process to match the job order 125 to multiple service providers can be implemented at one time. For example, the network system 100 can implement the matching process, where an objective function is solved that matches open job orders 125 with available provider records 135, resulting in identification of multiple service providers for individual job orders. For a given job order, a result of the matching process can include identification of an order or ranking amongst matched service providers, with the primary matched service provider corresponding to the highest order or ranked service provider, and the backup service provider having the next highest order or ranking.

In step 240, the network system 100 transmits a first communication that specifies the job order to a computing device associated with the first or primary service provider that is matched. The communication is transmitted to computing device of the first service provider, but not a computing device of any other service provider. In this way, upon completion of the matching process, the network system 100 makes the job order 125 available exclusively to the first or primary service provider. Further, the first communication can enable the matched first primary service provider to accept or not accept the job order 125. For example, network system 100 can transmit, over one or more networks, the job order communication 155, and enabling the user to accept or decline the job order 125, either through input or by default (e.g., with expiration of a timer).

In step 250, in response to a determination that the first service provider does not accept the job order, the network system 100 transmits a second communication that specifies the job order to a computing device associated with the second or backup service provider that is matched through the matching process. The communication is transmitted to computing device of the second or backup service provider, but not a computing device of any other service provider. In this way, the network system 100 makes the job order 125 exclusively available to the backup service provider. Further, the second communication can also enable the backup service provider to accept or decline the job order 125.

With reference to an example of FIG. 3, in step 310, in a first time interval, the network system 100 identifies a plurality of job orders. Each job order can be based on a transport request received during a particular time interval. When new transport requests are received, the network system 100 generates a new job order that corresponds to the transport request. Periodically (e.g., every ten seconds, etc.), the network system 100 identifies all of the open and pending job orders for matching. In step 312, the identified job orders include open job orders. Each open job order reflects a job order 125 that is unmatched at the particular time. Such open job orders 125 can include newly created job orders for newly received transport requests, as well as job orders that were previously matched to a service provider, but then not accepted by the service provider. To identify open job orders 125, the matching engine 140 can query the service data store 130 to identify job orders 125 having an open status.

As an addition or variation, in step 314, during the first time interval, the network system 100 can also identify pending job orders 125. In examples, each pending job order 125 has previously been exclusively communicated to a matched service provider, where it presently awaits acceptance or rejection. The identification of the open and pending job orders 125 can be performed at one time, or as a single step. For example, the matching engine 140 can query the service data store 130 to identify job orders 125 that have either an open or pending status.

In step 320, the network system 100 implements a matching process to match individual open job orders 125 of the open job orders 125 with each of a primary service provider and a backup service provider. As described with examples, an open service provider is one that (i) does not have a pending job order 125 to accept or decline, and (ii) is not currently assigned to a job order 125. As an addition or variation, the matching process can match the job order 125 to service providers of a pool of service providers that include open and pending service providers. Pending service providers include service provider that have been matched to a job order 125 that they have yet to accept or decline. Similarly, as described with other examples, an open job order 125 is one that is presently unmatched to a service provider. An open job order 125 can include job orders for newly received transport requests 105, as well as job orders 125 which were previously matched but not accepted by a service provider. Pending job orders 125 can include job orders that are matched to a service provider, but which have not been accepted by a service provider.

For open job orders, in step 322, the matching process can identify each of a primary service provider (sub-step 323) and a backup service provider (sub-step 324). In examples, the primary service provider is identified from a pool that includes service providers that have an open status. The backup service provider, on the other hand, is selected from a pool of service providers that includes both service providers that have an open status and service providers that have a pending status.

In examples, the matching process can be implemented to be selective as to which job order 125 are matched to backup service providers. In some examples, the matching process can determine an approval rate for individual job orders 125. If the approval rate is above a threshold (e.g., job order 125 is likely to be accepted), no backup service provider is matched. If, on the other hand, the approval rate is below a threshold (e.g., job order 125 is not likely to be accepted), then matching process matches the job order 125 to a backup service provider.

For pending job orders, in step 326, the matching process includes matching job orders that have a pending status. In sub-step 327, the matching process for pending job orders matches a backup service provider to the pending job order. In this way, the backup service providers for pending job orders 125 can be repeatedly refreshed, to better maintain the objectives of the matching process. The pool of available service providers that are used to match a backup service provider to a pending job order includes service providers that have an open status and service providers that have a pending status (e.g., received another job order that they can exclusively accept or not accept).

In some examples, service providers that have a pending status are considered available for matching purposes (as backup service providers) based on a determination of a likelihood of the service provider accepting a job order 125 that has been exclusively made available to the service provider. The determination of the likelihood can be based on the approval rate of the job order 125 that is currently pending with that service provider. As an addition or variation, the determination of the likelihood can be based on service provider-specific information, including historical data (e.g., indicating the service provider's propensity) and/or service provider profile information.

In step 330, the network system 100 makes individual job orders of the plurality of job orders exclusively available to a matched primary service provider. For example, when the matching process is performed for a given job order 125, the result of the matching process can identify multiple service providers, each with a score or ranking. The service provider with the highest score or ranking (or the “best match”) can initially be designated the primary service provider for the job order. In sub-step 332, the network system 100 can make the job order 125 exclusively available to that service provider by transmitting a job order communication 155 for that job order 125 to the matched primary service provider. No other service provider may receive communication for that job order while the job order is pending with the service provider. The job order communication 155 can enable the primary service provider to accept or not accept the corresponding job order 125. The primary service provider can then act on the job order communication 155 to accept or not accept the corresponding job order 125.

Still further, in some examples, the primary service provider can take no action on the job order communication 155 to allow for a default action to take place, where the job order is accepted or not accepted by default. Thus, in the latter case, the passage of a threshold time interval (e.g., 20 seconds) can cause the network system 100 to associate the job order 125 as being accepted or declined by default.

In step 336, a determination is made as to whether the primary service provider accepts or not accepts the matched job order 125. If the primary service provider accepts the matched job order 125, then in step 338, the job order 125 is assigned to the pending service provider, and the process for matching the particular job order is complete in step 340 (e.g., status of corresponding job order 125 is changed to closed, status of service provider is changed to assigned, etc.).

If the primary service provider does not accept the job order, then in step 342, a determination is made as to whether the job order 125 is presently matched to a backup service provider. If the determination is that the job order 125 is matched to a backup service provider, then in step 344, the backup service provider is changed to primary (e.g., change status of backup service provider to pending, coinciding with communication of the job order communication 155). This is done without reperforming the matching process (e.g., step 320). In cases where the job order 125 is associated with a backup service provider, examples provide that the method can be repeated from step 330, with the backup service provider being treated as the primary service provider. Thus, the network system 100 may transmit a communication to the former backup service provider (now current primary service provider) to enable that service provider to accept the job order 125, and the opportunity to accept (or not accept) the job order 125 may be exclusively enabled for that service provider. Further, these steps may be performed without the network system reperforming the matching process for that job order 125. On the other hand, if the determination is that the job order 125 is not matched to a backup service provider, then in step 346, the status of the job order is changed to open.

In variations, in response to a primary service provider not accepting a job order 125 that is also associated with a matched backup service provider, the job order 125 may be subjected to a rematching process (e.g., step 320) rather than having the matched backup service provider being made the primary service provider for the job order 125 (e.g., step 330). For example, the network system 100 can be configured to automatically rematch job orders 125 that have an approval rate that exceeds a designated threshold (e.g., indicating a high likelihood of acceptance), on the premise that such job orders 125 are unlikely to be rejected twice. As another example, if the job order 125 is repeatedly rejected by a primary and then a backup (or even an additional backup), the job order 125 can be subjected to the rematching process where a new primary service provider is identified (and possibly one or more backup service provider), rather than being assigned automatically to the current backup service provider. For example, if the interval between when the matching process is performed is relatively long, such that the matched backup service provider is “stale” (e.g., the interval between matching is one minute apart, and/or the backup service provider may have moved a distance to make acceptance more unlikely), then after one or multiple backup service providers declining to accept a job order, the job order may be subject to rematching (e.g., step 320) rather than having the job order be exclusively offered to another backup service provider.

In examples, the method 300 is repeated at intervals (e.g., every 10 seconds, 60 seconds, etc.). When the method 300 is re-performed after a backup service provider is promoted to exclusively receive a job order (in response to primary service provider not accepting the job order 125), a new backup service provider can be identified while the job order is pending acceptance/not acceptance by the promoted service provider. Likewise, if no backup service provider is matched to a job order that is declined by the matched primary service provider, the status of the job order 125 may be changed to open for when the matching process is performed again.

### Hardware Diagram

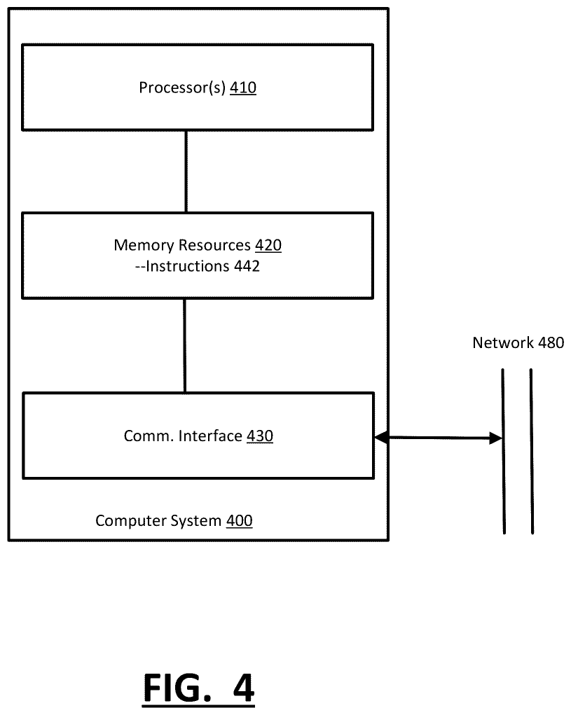

FIG. 4 is a block diagram that illustrates a computer system upon which one or more embodiments described herein may be implemented. For example, in the context of FIG. 1, the network system 100 may be implemented using a computer system or combination of computer systems, such as described with an example of FIG. 4. Additionally, methods such as described with examples of FIG. 2 and FIG. 3 may be implemented using a computer system such as described with an example of FIG. 4.

In one implementation, the computer system 400 includes one or more processors 410, memory resources 420, and a communication interface 430. The computer system 400 includes at least one processor 410 for processing information. The memory resources 420 may include a random-access memory (RAM) or other dynamic storage device, for storing information and instructions to be executed by the processor(s) 410. The memory resources 420 also may be used for storing temporary variables or other intermediate information during execution of instructions to be executed by the processor(s) 410. The computer system 400 may also include other forms of memory resources, such as static storage devices for storing static information and instructions for the processor 410. The memory resources 420 can store information and instructions, including instructions 442 for determining provisioning levels and positioning operations, in order to implement, for example, a transport matching service. Additionally, the processor(s) 410 can execute the instructions 442 to implement methods such as described with example methods of FIG. 2 and FIG. 3.

The communication interface 430 can enable the computer system 400 to communicate with one or more networks 480 (e.g., cellular network) through use of the network link (wireless or wireline). Using the network link, the computer system 400 can communicate with one or more other computing devices and/or one or more other servers or data centers. In some variations, the computer system 400 can receive transport requests from requester devices via the network link 480. Additionally, the computer system 400 can receive information from provider devices, from which forecasts of provisioning levels, location bias and other aspects described herein may be determined.

Examples described herein are related to the use of the computer system 400 for implementing the techniques described herein. According to one embodiment, those techniques are performed by the computer system 400 in response to the processor 410 executing one or more sequences of one or more instructions contained in the memory resources 420. Such instructions may be read into the memory resources 420 from another machine-readable medium, such as the storage device. Execution of the sequences of instructions contained in the memory resources 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network system comprising;
one or more processors;
a memory to store instructions;
wherein the one or more processors execute the instructions to perform operations that include:
receiving, over one or more networks, a transport request;
generating a job order based on the transport request;
during a first time interval, (i) performing a matching process to match the job order to multiple service providers, including a first service provider and a second service provider, and (ii) transmitting, over the one or more networks, a first communication that specifies the job order to a computing device of the first service provider but not to a computing device of any other service provider of the multiple service providers, the first communication enabling the first service provider to accept or not accept the job order; and
in response to a determination that the first service provider does not accept the job order, transmitting, over the one or more networks, without reperforming the matching process, a second communication that specifies the job order to a computing device of the second service provider but not to a computing device of any other service provider of the multiple service providers, the second communication enabling the second service provider to accept or not accept the job order using the computing device of the second service provider.

2. The network system of claim 1, wherein the operations further comprise:
making the determination that the first service provider does not accept the job order after passage of a threshold time interval during which no communication that accepts the job order is received from the computing device of the first service provide.

3. The network system of claim 1, wherein the operations further comprise:
making the determination that the first service provider does not accept the job order is based on receiving, over one or more networks, a response communication from the computing device of the first service provider.

4. The network system of claim 1, wherein the operations further comprise:
during the first time interval, determining an approval rate of the job order, and associating the approval rate with the job order.

5. The network system of claim 1, wherein the operations further comprise:
determining that the second service provider does not have a pending status corresponding to the second service provider having a prior job order that is currently pending only with the second service provider.

6. The network system of claim 5, wherein the operations further comprise:
associating the second service provider with the job order in response to determining that the second service provider does not have the pending status.

7. The network system of claim 5, wherein matching the job order to the second service provider is performed in response to determining that the second service provider does not have the pending status.

8. The network system of claim 4, wherein the determining the approval rate for the job order approval rate is based at least in part on parametric information of a corresponding transport request.

9. The network system of claim 8, wherein matching the job order to the second service provider is performed in response to determining the approval rate is less than a threshold value.

10. The network system of claim 4, wherein determining the approval rate is based on contextual information.

11. A non-transitory computer-readable medium that stores instructions, which when executed by one or more processors of a computer system, cause the computer system to perform operations that include:
during a first time interval, identifying a plurality of job orders, including multiple job orders that each have an open status such that no service provider is currently matched to the job order;
implementing a matching process to match individual job orders of the plurality of job orders with one or more service providers of a plurality of service providers, wherein for each job order of the multiple job orders that have the open status, implementing the matching process includes determining a matched primary service provider, and wherein for a first job order of the multiple job orders with the open status, implementing the matching process includes determining each of the matched primary service provider and a matched backup service provider;
for each job order of the multiple job orders having the open status, making the job order available to the matched primary service provider by transmitting a first communication to a computing device associated with the matched primary service provider, the first communication enabling the matched primary service provider to accept or not accept the job order; and
for at least the first job order of the multiple job orders, if the matched primary service provider does not accept the first job order, transmitting a second communication to a computing device associated with the backup service provider, the second communication enabling the matched backup service provider to accept or not accept the first job order.

12. The non-transitory computer-readable medium of claim 11, wherein identifying a plurality of job orders includes identifying multiple job orders that have a pending status, each job order with the pending status being currently matched to one of the plurality of service providers and awaiting the matched service provider to accept or not accept the job order; and
wherein for individual job orders of the multiple job orders having the pending status, implementing the matching process includes matching a backup service provider to the job order.

13. The non-transitory computer-readable medium of claim 11, wherein matching the backup service provider includes associating the job order with the matched backup service provider in place of a previously matched backup service provider.

14. The non-transitory computer-readable medium of claim 11, wherein the operations further comprise:
for each job order of the plurality of job orders, determining an approval rate based at least in part on parametric information of a transport request that corresponds to the job order.

15. The non-transitory computer-readable medium of claim 14, wherein for the first job order of the multiple job orders with the open status, making a determination as to whether to associate the first job order with a backup service provider is based at least in part on the approval rate.

16. The non-transitory computer-readable medium of claim 15, wherein making the determination to associate the first job order with the backup service provider includes determining whether an approval rate of the first job order exceeds a threshold value.

17. A computer-implemented method comprising:
during a first time interval, identifying a plurality of job orders, including multiple job orders that each have an open status such that no service provider is currently matched to the job order;
implementing a matching process to match individual job orders of the plurality of job orders with one or more service providers of a plurality of service providers, wherein for each job order of the multiple job orders that have the open status, implementing the matching process includes determining a matched primary service provider, and wherein for a first job order of the multiple job orders with the open status, implementing the matching process includes determining each of the matched primary service provider and a matched backup service provider;
for each job order of the multiple job orders having the open status, making the job order available to the matched primary service provider by transmitting a first communication to a computing device associated with the matched primary service provider, the first communication enabling the matched primary service provider to accept or not accept the job order; and
for at least the first job order of the multiple job orders, if the matched primary service provider does not accept the first job order, transmitting a second communication to a computing device associated with the backup service provider, the second communication enabling the matched backup service provider to accept or not accept the first job order.

18. The computer-implemented method of claim 17,
wherein identifying a plurality of job orders includes identifying multiple job orders that have a pending status, each job order with the pending status being currently matched to one of the plurality of service providers and awaiting the matched service provider to accept or not accept the job order; and
wherein for individual job orders of the multiple job orders having the pending status, implementing the matching process includes matching a backup service provider to the job order.

19. The computer-implemented method of claim 17, wherein matching the backup service provider includes associating the job order with the matched backup service provider in place of a previously matched backup service provider.

20. The computer-implemented method of claim 17, wherein the method further comprise:
for each job order of the plurality of job orders, determining an approval rate based at least in part on parametric information of a transport request that corresponds to the job order.
